(19) United States
(12) Patent Application Publication
(10) Pub. No.: US 2026/0175790 A1
(43) Pub. Date: Jun. 25, 2026

(54) VEHICULAR CAMERA

(71) Applicant: Panasonic Automotive Systems Co., Ltd., Kanagawa (JP)

(72) Inventors: Kouichi KAWAMOTO, Osaka (JP); Yoshiki USUI, Kanagawa (JP)

(73) Assignee: Panasonic Automotive Systems Co., Ltd., Kanagawa (JP)

(21) Appl. No.: 19/331,703

(22) Filed: Sep. 17, 2025

(30) Foreign Application Priority Data
Dec. 25, 2024 (JP) 2024-229296

(51) Int. Cl. B60R 11/04; G03B 17/02; G03B 30/00; H04N 23/51; H04N 23/57

(52) U.S. Cl. CPC B60R 11/04; G03B 17/02; G03B 30/00; H04N 23/51; H04N 23/57

(57) ABSTRACT

A vehicular camera include a lens unit having a lens barrel and a flange portion formed at a second end portion of the lens barrel, an imaging element, a circuit board, a housing accommodating the imaging element and the circuit board, and a shield attached to a third surface of the flange portion. The flange portion includes a first reference protrusion provided at a position corresponding to the first side of the third surface, and a first crushable protrusion provided at a position corresponding to the third side facing the first side of the third surface. The shield has, at a position corresponding to the seventh side facing the fifth side, a first bent-up piece formed by bending up a part of the shield, and the first bent-up piece abuts against the first crushable protrusion of the flange portion.

### TECHNICAL FIELD

The present disclosure relates to a vehicular camera.

With demands for improvements in vehicle safety, introduction of autonomous driving functions and the like in recent years, development of vehicular cameras that are mounted on vehicles and capture the inside and outside of the vehicles has become active (for example, see Patent Literature 1).

### CITATION LIST

### Patent Literature

Patent Literature 1: WO2024/004821

### SUMMARY OF INVENTION

Required levels relating to safety, automatic driving functions, and the like, which are required for vehicles, are improved, and further improvement in performance and the like are also required for vehicular cameras.

The present disclosure relates to a technique for providing a new vehicular camera.

The present disclosure provides a vehicular camera including: a lens unit including a lens barrel having a first tubular portion along an optical axis and including a first end portion of the first tubular portion and a second end portion opposite to the first end portion, at least one lens disposed in the lens barrel, and a flange portion formed at the second end portion of the lens barrel to spread outward in a direction orthogonal to the optical axis; an imaging element disposed on the optical axis and closer to the second end portion than the first end portion of the first tubular portion of the lens barrel; a circuit board including a first surface and a second surface opposite to the first surface, the imaging element being disposed on the first surface; a housing having a second tubular portion along the optical axis, including a third end portion of the second tubular portion and a fourth end portion opposite to the third end portion and disposed farther, than the third end portion of the second tubular portion, away from the first end portion of the first tubular portion of the lens barrel, the third end portion of the second tubular portion supporting the flange portion of the lens unit, and configured to accommodate the imaging element and the circuit board; and a shield made of metal and attached to a third surface of the flange portion of the lens unit, the third surface facing the imaging element. The flange portion of the lens unit has a rectangular shape in a plan view orthogonal to the optical axis, and has a first side, a second side, a third side, and a fourth side. The flange portion includes a reference rib provided at a position corresponding to the first side of the third surface and configured to determine a reference position of the lens unit relative to the housing when the lens unit is attached to the third end portion of the housing, and a crush rib provided at a position corresponding to the third side facing the first side of the third surface, the crush rib being at least partially crushed when the lens unit is attached to the third end portion of the housing.

The shield has a rectangular shape in the plan view orthogonal to the optical axis and has a fifth side, a sixth side, a seventh side, and an eighth side, the fifth side corresponds to the first side of the flange portion, the sixth side corresponds to the second side of the flange portion, the seventh side corresponds to the third side of the flange portion, and the eighth side corresponds to the fourth side of the flange portion. The shield includes a first hook portion that is provided at a position corresponding to the sixth side, is elastically deformable, and engages with the flange portion of the lens unit, and a second hook portion that is provided at a position corresponding to the eighth side facing the sixth side, is elastically deformable, and engages with the flange portion of the lens unit.

Further, the present disclosure provides a vehicular camera including a lens unit including a lens barrel having a first tubular portion along an optical axis and including a first end portion of the first tubular portion and a second end portion opposite to the first end portion, at least one lens disposed in the lens barrel, and a flange portion formed at the second end portion of the lens barrel to spread outward in a direction orthogonal to the optical axis; an imaging element disposed on the optical axis and closer to the second end portion than the first end portion of the first tubular portion of the lens barrel; a circuit board including a first surface and a second surface opposite to the first surface, the imaging element being disposed on the first surface; a housing accommodating the imaging element and the circuit board, having a second tubular portion along the optical axis, including a third end portion of the second tubular portion and a fourth end portion opposite to the third end portion and disposed farther, than the third end portion of the second tubular portion, away from the first end portion of the first tubular portion of the lens barrel, the third end portion of the second tubular portion supporting the flange portion of the lens unit; and a shield made of metal and attached to a third surface of the flange portion of the lens unit, the third surface facing the imaging element. The flange portion of the lens unit has a rectangular shape in a plan view orthogonal to the optical axis, and has a first side, a second side, a third side, and a fourth side. The flange portion includes a first reference protrusion provided at a position corresponding to the first side of the third surface and configured to determine a reference position of the shield relative to the flange portion when the shield is attached to the flange portion, and a first crushable protrusion provided at a position corresponding to the third side facing the first side of the third surface, the first crushable protrusion being at least partially crushed when the shield is attached to the flange portion. The shield has a rectangular shape in the plan view orthogonal to the optical axis and has a fifth side, a sixth side, a seventh side, and an eighth side, the fifth side corresponds to the first side of the flange portion and abuts against the first reference protrusion of the flange portion, the sixth side corresponds to the second side of the flange portion, the seventh side corresponds to the third side of the flange portion, and the eighth side corresponds to the fourth side of the flange portion. The shield has, at a position corresponding to the seventh side facing the fifth side, a first bent-up piece formed by bending up a part of the shield, and the first bent-up piece abuts against the first crushable protrusion of the flange portion.

According to the present disclosure, the shield that shields noise can be easily attached to the flange portion of the lens unit using a simple configuration including two elastically deformable hook portions.

Further, according to the present disclosure, the shield can be attached to the flange portion with a simple configuration using the first bent-up piece formed by bending up a part of the shield.

### BRIEF DESCRIPTION OF DRAWINGS

FIG. 1 is an example of a vehicle, and is a top view of the vehicle on which vehicular cameras are mounted;

FIG. 2 is a block diagram illustrating a connection example of the vehicular cameras provided in the vehicle illustrated in FIG. 1, a camera ECU, and a display;

FIG. 3 is another example of the vehicle, and is a schematic diagram of a cabin of the vehicle on which a vehicular camera is mounted;

FIG. 4 is a top view of the vehicle in FIG. 3;

FIG. 5 is a block diagram illustrating a connection example of the vehicular camera provided in the vehicle illustrated in FIG. 3, a camera ECU, and a display device;

FIG. 6 is a front perspective view of the vehicular camera according to a first embodiment;

FIG. 7 is a rear perspective view of the vehicular camera according to the first embodiment;

FIG. 8 is an exploded perspective view of the vehicular camera according to the first embodiment;

FIG. 9 is a top view of the vehicular camera according to the first embodiment.

FIG. 10 is a cross-sectional view taken along a line I-I in FIG. 9;

FIG. 11 is a bottom view of a lens unit in the vehicular camera according to the first embodiment;

FIG. 12 is a bottom view of the lens unit to which a front shield is attached in the vehicular camera according to the first embodiment;

FIG. 13 is a perspective view of the lens unit to which the front shield is attached in the vehicular camera according to the first embodiment as viewed from the front shield side along one direction;

FIG. 14 is a perspective view of the lens unit to which the front shield is attached in the vehicular camera according to the first embodiment as viewed from the front shield side along another direction;

FIG. 15 is an enlarged view of a portion A in FIG. 14;

FIG. 16 is an exploded perspective view of a vehicular camera according to a second embodiment;

FIG. 17 is a bottom view of the lens unit to which a front shield is attached in the vehicular camera according to the second embodiment;

FIG. 18 is a perspective view of the lens unit to which the front shield is attached in the vehicular camera according to the second embodiment as viewed from the front shield side along one direction;

FIG. 19 is a perspective view of the lens unit to which the front shield is attached in the vehicular camera according to the second embodiment as viewed from the front shield side along another direction;

FIG. 20 is an enlarged view of a portion B in FIG. 18;

FIG. 21 is an enlarged view of a portion C in FIG. 11 as viewed obliquely from above;

FIG. 22 is an enlarged view of a portion D in FIG. 18 as viewed obliquely from above;

FIG. 23 is an enlarged view of a portion E in FIG. 11 as viewed obliquely from above; and

FIG. 24 is an enlarged view of a portion F in FIG. 18 as viewed obliquely from above.

### DESCRIPTION OF EMBODIMENTS

Hereinafter, embodiments that specifically disclose a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following descriptions and to facilitate understanding of those skilled in the art. It should be noted that the accompanying drawings and the following description are provided for a person skilled in the art to fully understand the present disclosure, and are not intended to limit the subject matter described in the claims.

### Vehicle on Which Vehicular Cameras are Mounted

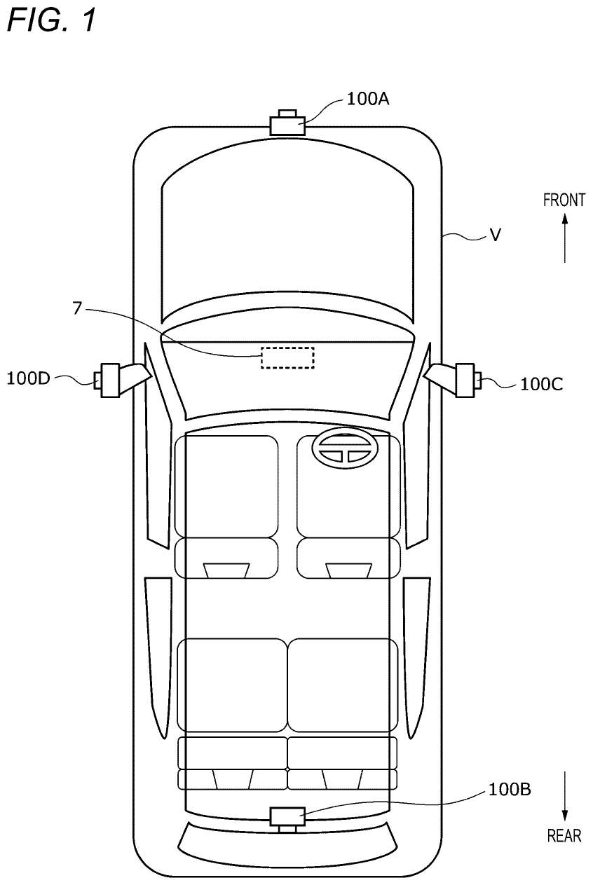

FIG. 1 is an example of a vehicle, and is a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images showing an entire periphery of the vehicle V.

For example, the vehicular camera 100A is provided in a front grille of the vehicle V, and captures an image of a front region in a direction of looking down obliquely with respect to the ground. The vehicular camera 100B is provided in a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

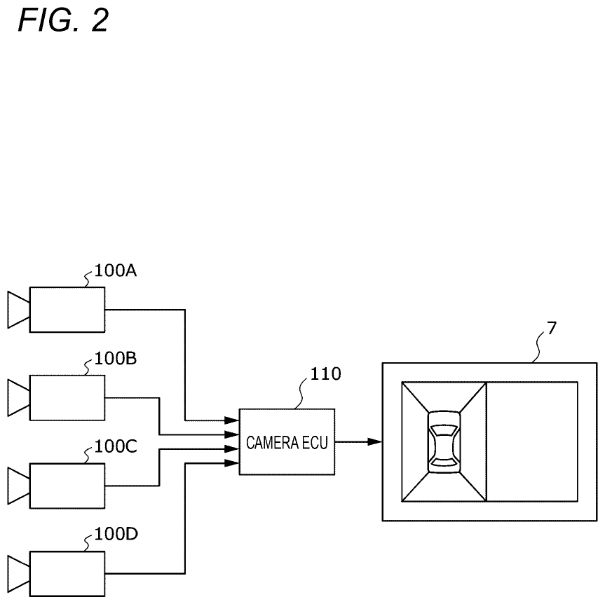

FIG. 2 is a block diagram illustrating a connection example of the vehicular cameras 100A to 100D provided in the vehicle V illustrated in FIG. 1, a camera ECU 110, and a display 7. The camera electronic control unit (ECU) 110 in FIG. 2 synthesizes the images captured by the vehicular cameras 100A to 100D, and displays a synthesized image on the display 7 of a navigation system disposed on an instrument panel, for example. An occupant can visually recognize the display 7 and check a situation around the vehicle V.

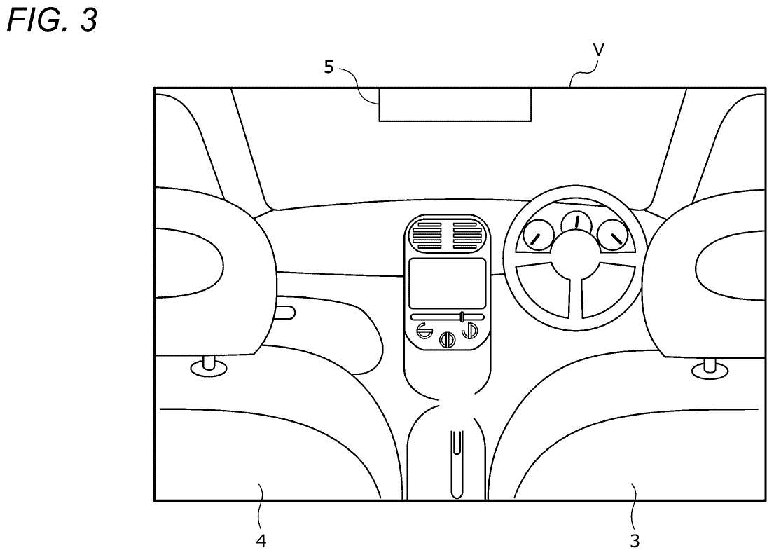

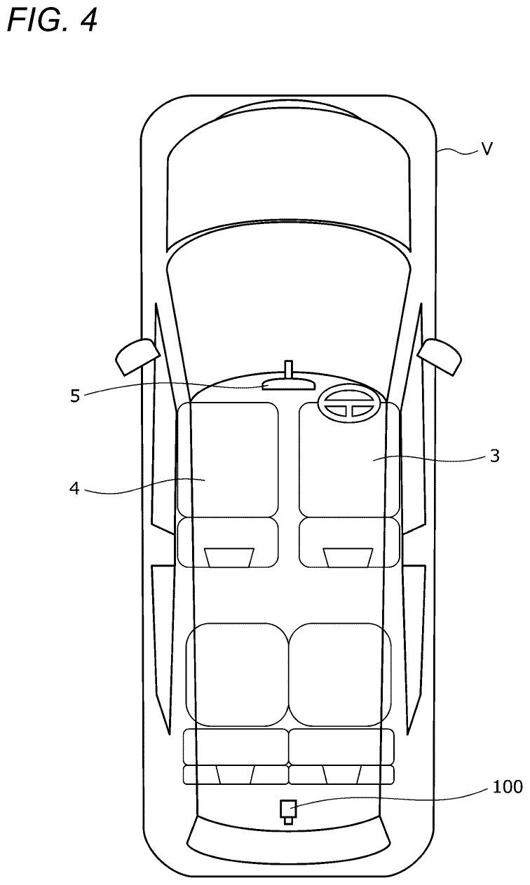

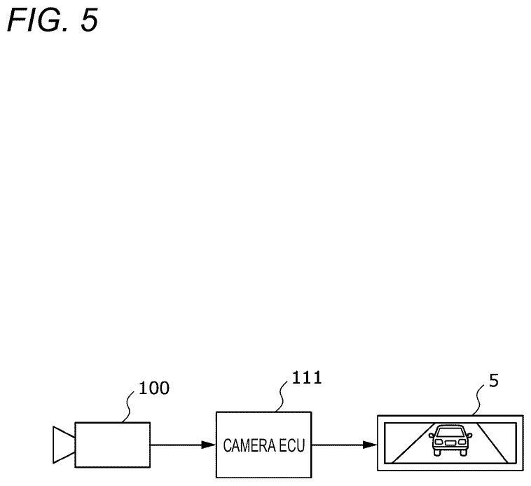

FIG. 3 is another example of the vehicle, and is a schematic diagram of a cabin of the vehicle on which the vehicular camera is mounted, and FIG. 4 is a top view of the vehicle in FIG. 3. The vehicle V includes a display device 5 (for example, an electronic rearview mirror) at an attachment position of a rearview mirror, which is a front portion between a driver's seat 3 and a passenger seat 4 in a cabin 2. Further, the vehicle V is provided with the vehicular camera 100 at a rear side of a vehicle body. FIG. 5 is a block diagram illustrating a connection example of the vehicular camera 100 provided in the vehicle V illustrated in FIG. 3, a camera ECU 111, and the display device 5. The camera electronic control unit (ECU) 111 in FIG. 4 processes an image captured by the vehicular camera 100, and the display device 5 displays the image. The occupant can visually recognize the display device 5 and check a rear situation of the vehicle V.

### Vehicular Camera According to First Embodiment

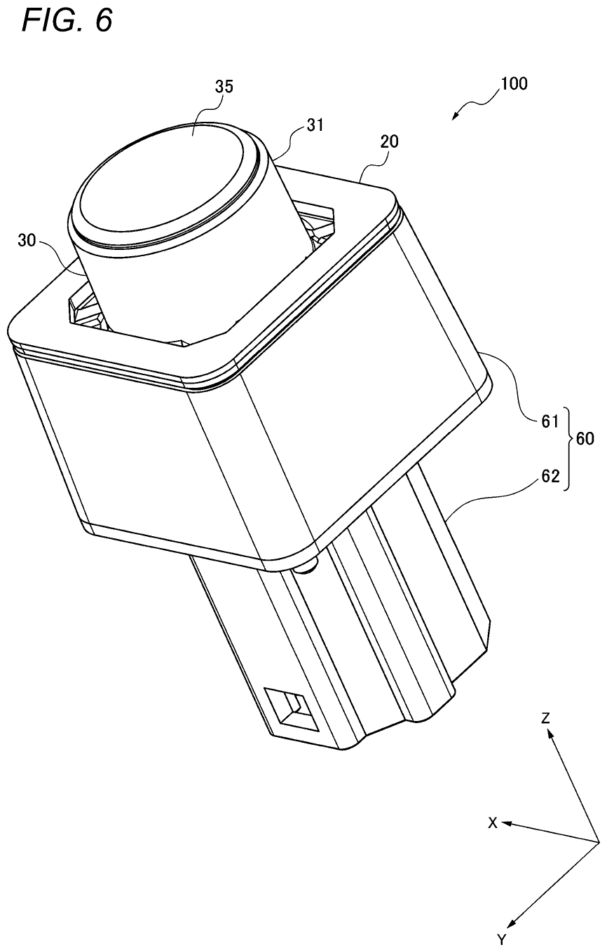

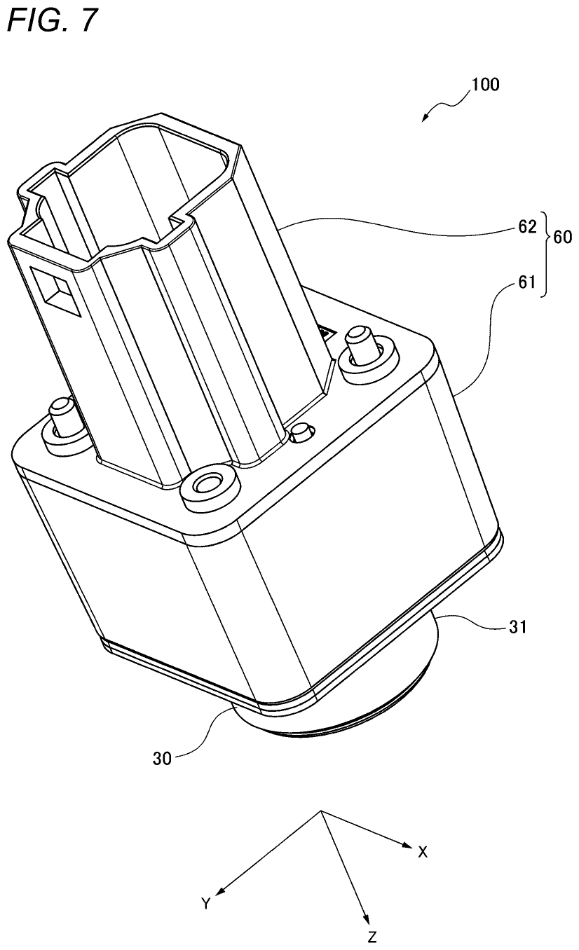

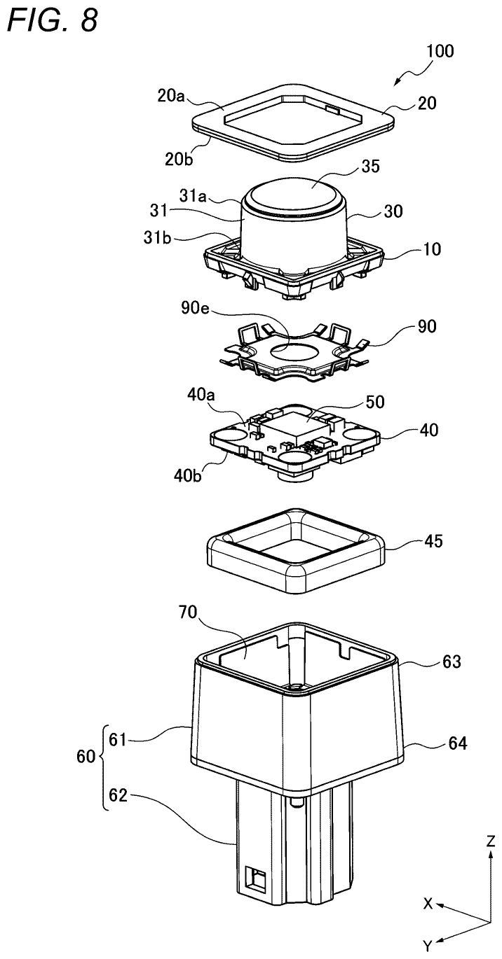

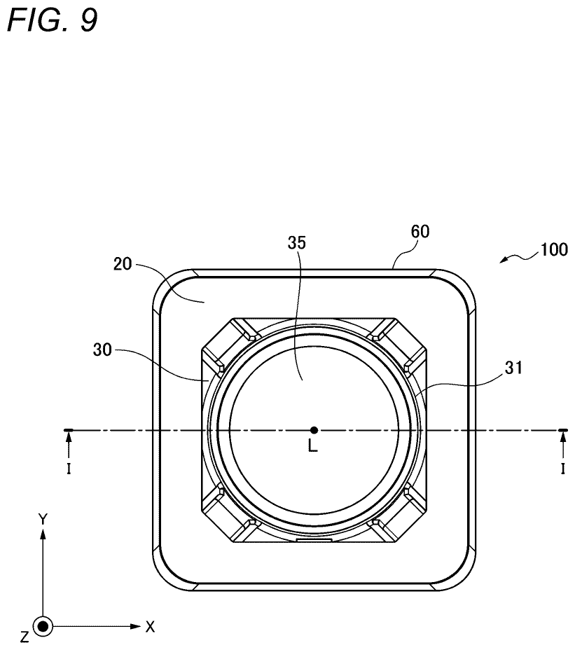

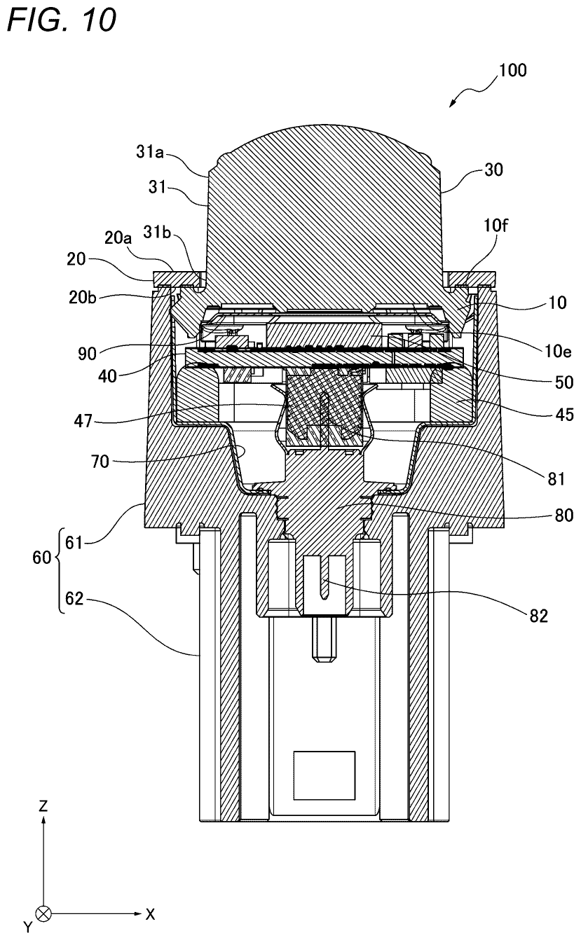

FIG. 6 is a front perspective view of the vehicular camera 100 according to a first embodiment. FIG. 7 is a rear perspective view of the vehicular camera 100 according to the first embodiment. FIG. 8 is an exploded perspective view of the vehicular camera 100 according to the first embodiment. FIG. 9 is a top view of the vehicular camera 100 according to the first embodiment. FIG. 10 is a cross-sectional view taken along a line I-I in FIG. 9. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 according to the present embodiment includes a ring member 20, a lens unit 30, a circuit board 40, an imaging element 50, a housing 60, a rear shield 70, and a front shield (shield) 90.

The ring member 20 is configured by a flat plate-shaped member including a first surface 20a and a second surface 20b opposite to the first surface 20a. The second surface 20b of the ring member 20 is welded to the lens unit 30 and the housing 60 by laser welding. An inner peripheral surface of the ring member 20 faces an outer peripheral surface of a lens barrel 31 of the lens unit 30. An inner diameter of the ring member 20 has a length that allows insertion of the lens barrel 31.

The ring member 20 can be formed of a first resin having a predetermined light transmittance. Accordingly, the ring member 20 can be easily formed at low cost.

The lens unit 30 includes the lens barrel 31. As illustrated in FIGS. 9 and 10, the lens barrel 31 has a first tubular portion along an optical axis L (a direction orthogonal to the sheet of FIG. 9 and along the Z axis), and has a first end portion 31a of the first tubular portion and a second end portion 31b opposite to the first end portion 31a. The first end portion 31a forms a distal end portion of the lens barrel 31, and at least a part of the second end portion 31b faces the imaging element 50 and the circuit board 40 inside the housing 60.

The lens unit 30 also includes at least one lens 35 disposed on the optical axis L and in the lens barrel 31. The lens barrel 31 may hold therein, for example, a lens group including a plurality of lenses 35. When the lens group is arranged, the respective lenses are arranged in a state in which respective optical axes L are aligned with each other and are used for capturing images of the inside and outside of the vehicle body of the vehicle V.

Further, the lens unit 30 has, at the second end portion 31b of the lens barrel 31, a flange portion 10 formed to spread outward with reference to the optical axis L over an entire circumference centering on the optical axis L. The flange portion 10 has a third surface 10e facing an inside of the housing 60 and a fourth surface 10f facing at least a part of the second surface 20b of the ring member 20.

At least the fourth surface 10f of the flange portion 10 can be formed of a second resin having a first light absorptivity. The flange portion 10 may be entirely formed of the second resin. Accordingly, the flange portion 10 can be easily formed at low cost. The lens barrel 31 and the flange portion 10 may be separate members or may be bonded via an adhesive or the like. The lens barrel 31 and the flange portion 10 may be integrally formed.

In the present embodiment, the flange portion 10 has a rectangular shape (for example, a square shape) in a plan view orthogonal to the optical axis L, and has four sides such as a first side 10a, a second side 10b, a third side 10c, and a fourth side 10d.

The imaging element 50 is disposed in an internal space of the housing 60 on the optical axis L and closer to the second end portion 31b than the first end portion 31a of the lens barrel 31. The imaging element 50 is electrically connected to a circuit of the circuit board 40, and can capture an image by directing external light to the imaging element 50. The imaging element 50 may be, for example, a complementary metal-oxide-semiconductor (CMOS) image sensor.

The circuit board 40 is disposed in an internal space of the housing 60, and includes a first surface 40a and a second surface 40b opposite to the first surface 40a. However, two or more circuit boards may be provided. The imaging element 50 is disposed on the first surface 40a of the circuit board 40.

The circuit board 40 has a first shape in the plan view. The first shape in a plan view is a shape when viewed in a direction from the first surface 40a to the second surface 40b of the circuit board 40. The first shape is, for example, a quadrangular shape as in the embodiment, but may be a polygonal shape having five or more sides.

The housing 60 is a tubular member having the internal space, and serves to accommodate at least the circuit board 40 and the imaging element 50. The housing 60 includes a large-diameter tubular portion 61 having a second tubular shape along the optical axis L, a third end portion 63, and a fourth end portion 64. The third end portion 63 is connected to the lens unit 30. The fourth end portion 64 is opposite to the third end portion 63 in a direction along the optical axis L, and is disposed farther, than the third end portion 63, away from the first end portion 31a of the lens barrel 31.

The housing 60 further includes a small-diameter tubular portion 62 that is formed continuously with the fourth end portion 64, protrudes in a direction away from the circuit board 40 in the direction along the optical axis L, and has a diameter smaller than a diameter of the large-diameter tubular portion 61. However, the housing 60 does not necessarily include the large-diameter tubular portion 61 and the small-diameter tubular portion 62 having different diameters.

The large-diameter tubular portion 61 and the small-diameter tubular portion 62 may be integrally formed, and the large-diameter tubular portion 61 and the small-diameter tubular portion 62 prepared individually in advance may be bonded by a method such as welding or screwing. In the present embodiment, the housing 60 has a rectangular tubular shape, but is not limited thereto, and may have a polygonal tubular shape other than the rectangular tubular shape, a circular or elliptical tubular shape, or another tubular shape.

In a state in which the housing 60 accommodates at least the circuit board 40 and the imaging element 50, the ring member 20 is welded to the flange portion 10 of the lens unit 30 on a radially inner side, and is welded to the third end portion 63 of the housing 60 on a radially outer side over the entire circumference. The welding is performed by, for example, laser welding.

General laser welding is used for welding, for example, a first resin having a predetermined light transmittance and a second resin or a third resin having a light transmittance lower than the light transmittance of the first resin at a wavelength of laser light. When the first resin is irradiated with the laser light in a state in which pressure is applied to both the resins, the laser light is not absorbed and passes through the first resin. The transmitted laser light is absorbed by a surface of the second resin or the third resin having a light transmittance lower than that of the first resin. The energy of the absorbed laser is converted into heat, and the surface of the second resin or the third resin is heated. Further, a surface of the first resin in contact with the surface of the second resin or the third resin is also heated due to heat conduction. Accordingly, the first resin and the second resin or the third resin are melted at a boundary surface therebetween. When the laser emission is stopped, the melted resin is solidified and both resins are welded.

In the present embodiment, the ring member 20 is formed of the first resin, and at least the fourth surface 10f of the flange portion 10 of the lens unit 30 is formed of the second resin having the first light absorptivity. The third end portion 63 of the housing 60 is formed of the third resin having a second light absorptivity.

In the laser welding, first, in a state in which the second surface 20b of the ring member 20 is pressed against the fourth surface 10f of the flange portion 10 of the lens unit 30, the laser is emitted to weld the second surface 20b of the ring member 20 and the fourth surface 10f. Thereafter, in a state in which the second surface 20b of the ring member 20 is pressed against the third end portion 63 of the housing 60, the laser is emitted to weld the second surface 20b of the ring member 20 and the third end portion 63. Accordingly, the lens unit 30 and the housing 60 are integrated via the ring member 20, and the third end portion 63 of the housing 60 supports the flange portion 10 via the ring member 20.

The rear shield 70 is a box-shaped conductive member accommodated along an inner surface of the housing 60, particularly the large-diameter tubular portion 61, inside the housing 60. The rear shield 70 is formed of a conductive metal or the like and serves to shield internal and external noise of the housing 60. The front shield 90 is attached to the third surface 10e of the flange portion 10 facing the imaging element 50 inside the housing 60. The front shield 90 is formed of a conductive metal or the like and serves to shield internal and external noise of the housing 60.

The vehicular camera 100 includes an external connector 80 provided at the fourth end portion 64 of the housing 60. The external connector 80 includes a first connector end portion 81 and a second connector end portion 82 opposite to the first connector end portion 81, and is set such that the first connector end portion 81 is connected to a connector connection portion 47 disposed on the second surface 40b of the circuit board 40 and an image signal from the imaging element 50 is output to an outside.

The vehicular camera 100 further includes a resin member 45 disposed inside the housing 60. The resin member 45 serves to dissipate heat from the circuit board 40 to the outside, for example.

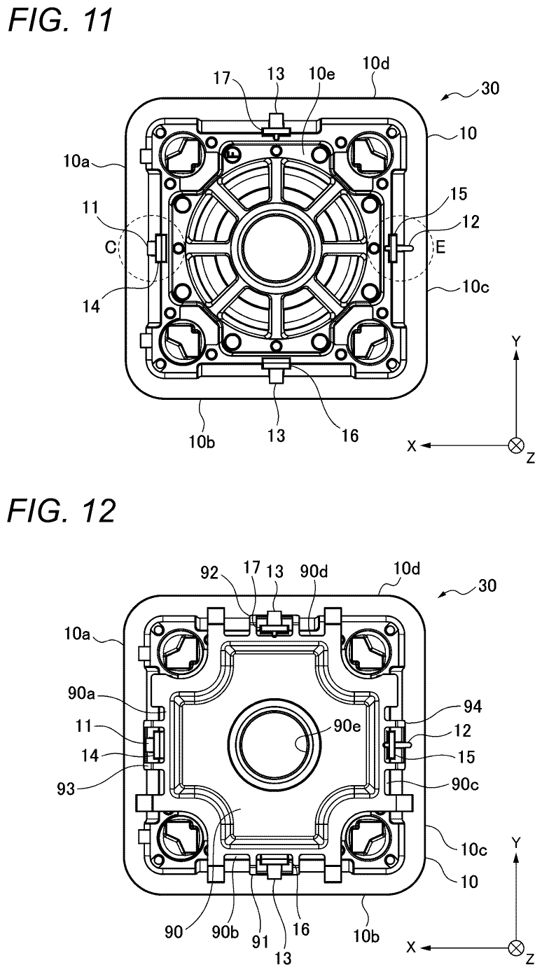

FIG. 11 is a bottom view of the lens unit 30 in the vehicular camera 100 according to the first embodiment. FIG. 12 is a bottom view of the lens unit 30 to which the front shield 90 is attached in the vehicular camera 100 according to the first embodiment. The bottom view of the lens unit 30 corresponds to a view of the lens unit 30 viewed from the third surface 10e side of the flange portion 10. The front shield 90 has a transmission hole 90e at a center thereof, and light passing through the lens barrel 31 from the outside passes through the transmission hole 90e and is guided to the imaging element 50.

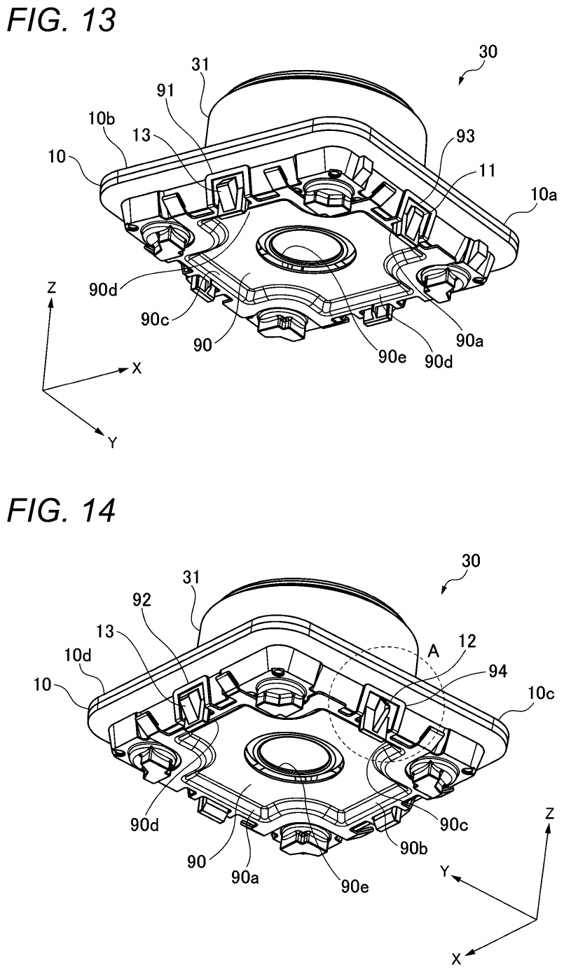

FIG. 13 is a perspective view of the lens unit 30 to which the front shield 90 is attached as viewed from the front shield 90 side along one direction. FIG. 14 is a perspective view of the lens unit 30 to which the front shield 90 is attached as viewed from the front shield 90 side along another direction. FIG. 13 and FIG. 14 are substantially the same diagram except for the direction of the viewpoint.

In the actual assembly of the vehicular camera 100, first, the rear shield 70 is accommodated inside the housing 60, and the front shield 90 is attached to the third surface 10e of the flange portion 10 of the lens unit 30 as illustrated in FIGS. 12 to 14. Thereafter, the lens unit 30 to which the front shield 90 is attached is fitted into the third end portion 63 of the housing 60, and the above-described laser welding (laser welding between the ring member 20 and the lens unit 30 and laser welding between the ring member 20 and the housing 60) is performed. Therefore, it is important to prevent the front shield 90 from falling off the flange portion 10.

A structure related to fitting of the lens unit 30 into the housing 60 will be described. The flange portion 10 of the lens unit 30 includes a reference rib 11 and a crush rib 12. The reference rib 11 is a member that is provided at a position corresponding to the first side 10a of the third surface 10e of the flange portion 10, and determines a reference position of the lens unit 30 relative to the housing 60 when the lens unit 30 is attached to the third end portion 63 of the housing 60. On the other hand, the crush rib 12 is a member that is provided at a position corresponding to the third side 10c facing the first side 10a of the third surface 10e and is at least partially crushed when the lens unit 30 is attached to the third end portion 63 of the housing 60.

That is, the reference rib 11 is brought into contact with an inner surface of the third end portion 63 of the housing 60 in a state in which the flange portion 10 of the lens unit 30 is inclined with respect to the third end portion 63 of the housing 60. At this time, the first side 10a of the flange portion 10 is close to the third end portion 63, and the third side 10c is away from the third end portion 63. From this state, when the third side 10c approaches the third end portion 63 and a posture of the flange portion 10 approaches parallel to the third end portion 63, the crush rib 12 of the third surface 10e starts to come into contact with the inner surface of the third end portion 63. When the third side 10c is brought even closer to the third end portion 63, the crush rib 12 is crushed while sliding on the inner surface of the third end portion 63, and finally, the flange portion 10 becomes parallel to the third end portion 63, and the flange portion 10 is supported inside the third end portion.

As illustrated in FIGS. 12 to 14, before the fitting step described above, the front shield 90 is attached to the third surface 10e of the flange portion 10 of the lens unit 30. Hereinafter, a structure for preventing the front shield 90 from detaching from the flange portion 10 in the fitting step will be described.

The front shield 90 has a rectangular shape in the plan view orthogonal to the optical axis L, and has a fifth side 90a, a sixth side 90b, a seventh side 90c, and an eighth side 90d. The fifth side 90a corresponds to the first side 10a of the flange portion 10, the sixth side 90b corresponds to the second side 10b of the flange portion 10, the seventh side 90c corresponds to the third side 10c of the flange portion 10, and the eighth side 90d corresponds to the fourth side 10d of the flange portion 10.

The front shield 90 further includes a first hook portion 91, a second hook portion 92, a third hook portion 93, and a fourth hook portion 94. The first hook portion 91 is provided at a position corresponding to the sixth side 90b, is elastically deformable, and engages with the flange portion 10 of the lens unit 30. The second hook portion 92 is provided at a position corresponding to the eighth side 90d facing the sixth side 90b, is elastically deformable, and engages with the flange portion 10 of the lens unit 30. The third hook portion 93 is provided at a position corresponding to the fifth side 90a, is elastically deformable, and engages with the flange portion 10 of the lens unit 30. The fourth hook portion 94 is provided at a position corresponding to the seventh side 90c facing the fifth side 90a, is elastically deformable, and engages with the flange portion 10 of the lens unit 30.

According to the present embodiment, the front shield 90 that shields noise can be attached to the flange portion 10 of the lens unit 30 using four elastically deformable hook portions, and the front shield 90 can be prevented from falling off the flange portion 10.

FIG. 15 is an enlarged view of a portion A in FIG. 14. FIG. 15 illustrates a state in which the fourth hook portion 94 is engaged with the third side 10c of the flange portion 10. Each hook portion represented by the fourth hook portion 94 includes a pair of extending pieces 97 extending from a main body of the front shield 90 and a connecting piece 98 connecting distal ends of the extending pieces 97. The pair of extending pieces 97 are elastically deformable with respect to the main body of the front shield 90.

When the front shield 90 is attached to the flange portion 10, the connecting piece 98 of the fourth hook portion 94 comes into contact with a sliding surface 12a of the crush rib 12 as the front shield 90 approaches the third surface 10e of the flange portion 10. The sliding surface 12a is originally a surface that slides with respect to the inner surface of the third end portion 63 when the flange portion 10 is attached to the third end portion 63 of the housing 60. When the front shield 90 is brought closer to the third surface 10e of the flange portion 10, the sliding surface 12a pushes and expands the fourth hook portion 94. When the front shield 90 is further brought closer to the third surface 10e of the flange portion 10, the connecting piece 98 climbs over the sliding surface 12a, reaching the state illustrated in FIG. 15 in which the fourth hook portion 94 engages with the third side 10c of the flange portion 10 due to an elastic force of the extending piece 97. Such an engagement process also applies to the relationship between the third hook portion 93 and the reference rib 11.

The sliding surface 12a has a second angle θ₂ inclined with respect to a direction parallel to the optical axis L. The second angle θ₂ is set to be large to some extent in order to secure a predetermined force when sliding on the inner surface of the third end portion 63 in the fitting step described above. That is, the sliding surface 12a is inclined at an angle greater than the predetermined angle.

In a case where the front shield 90 is attached to the flange portion 10, when the connecting piece 98 of the fourth hook portion 94 comes into contact with and slides on the sliding surface 12a having a large inclination angle, a large force acts on the sliding surface 12a, the sliding surface 12a is scraped more than expected, and unnecessary shavings are generated, which may cause an unexpected problem in the vehicular camera 100.

### Vehicular Camera According to Second Embodiment

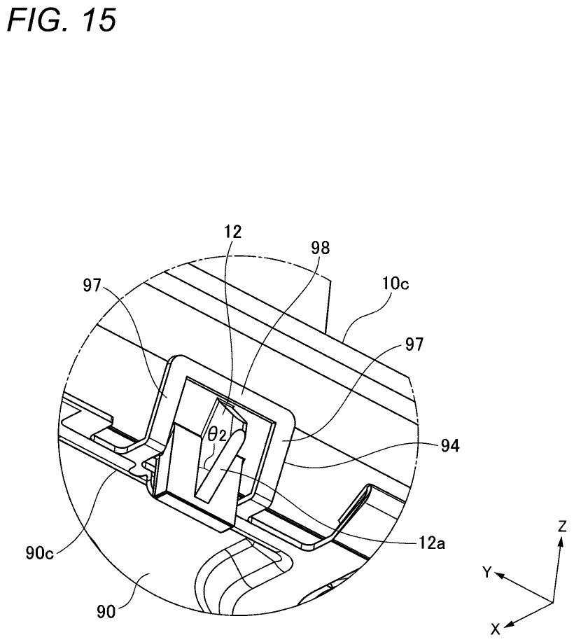

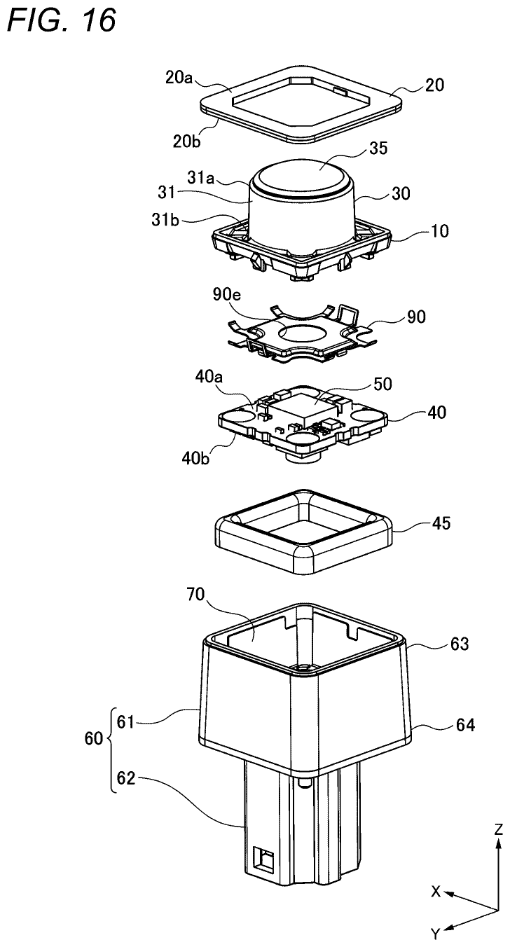

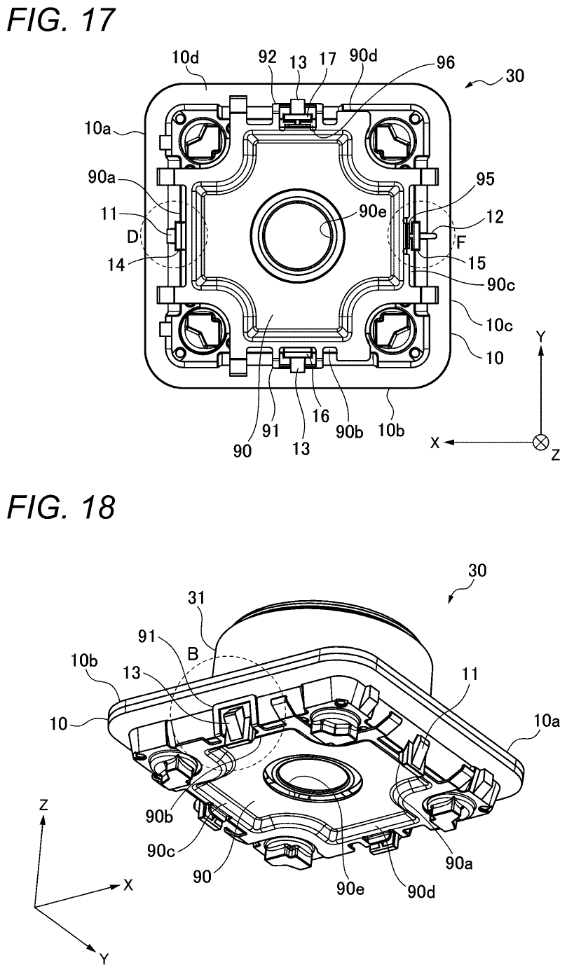

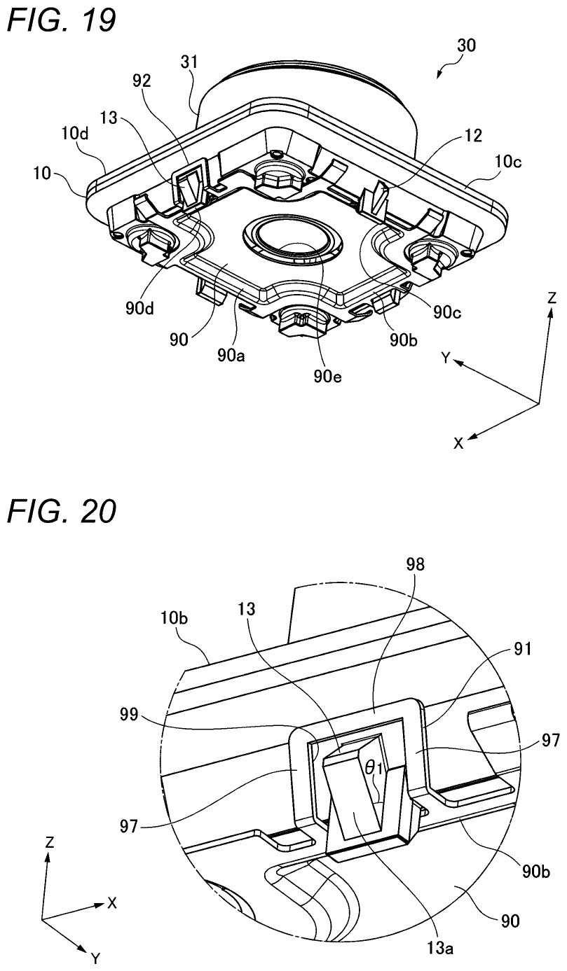

FIG. 16 is an exploded perspective view of the vehicular camera 100 according to a second embodiment. FIG. 17 is a bottom view of a lens unit to which the front shield 90 is attached in the vehicular camera 100 according to the second embodiment. FIG. 18 is a perspective view of the lens unit 30 to which the front shield 90 is attached in the vehicular camera 100 according to the second embodiment as viewed from the front shield 90 side along one direction. FIG. 19 is a perspective view of the lens unit 30 to which the front shield 90 is attached in the vehicular camera 100 according to the second embodiment as viewed from the front shield 90 side along another direction.

The appearance and the like of the vehicular camera 100 according to the second embodiment are common to those of FIGS. 6 to 10 in the first embodiment, but the vehicular camera 100 according to the second embodiment is a mode for solving the problem described last in the first embodiment. The present embodiment is different from the first embodiment in that the front shield 90 includes the first hook portion 91 and the second hook portion 92, but does not include the third hook portion 93 and the fourth hook portion 94.

That is, the first hook portion 91 and the second hook portion 92 are provided on the sixth side 90b and the eighth side 90d, but no hook portion is provided on the fifth side 90a and the seventh side 90c. Therefore, the configuration of the front shield 90 of the present embodiment is simpler than that of the first embodiment.

In the present embodiment, as illustrated in FIG. 15, since there is no fourth hook portion 94 corresponding to the crush rib 12, there is no problem that shavings of the sliding surface 12a are generated when the front shield 90 is attached to the flange portion 10 as described above. Since there is no third hook portion 93 corresponding to the reference rib 11 in the first embodiment, there is no problem that shavings are generated from the reference rib 11.

The first hook portion 91 and the second hook portion 92 have an elastic retention force necessary for holding the front shield 90 against the flange portion 10 of the lens unit 30, and even if the third hook portion 93 and the fourth hook portion 94 are omitted, the risk of the front shield 90 falling off the flange portion 10 during assembly can be ignored.

According to the present embodiment, the front shield 90 that shields noise can be easily attached to the flange portion 10 of the lens unit 30 using a simple configuration including two elastically deformable hook portions, and the front shield 90 can be prevented from falling off the flange portion 10.

It can be said that the fifth side 90a and the seventh side 90c of the front shield 90 have no hook portions other than the first hook portion 91 and the second hook portion 92 of the sixth side 90b and the eighth side 90d. Accordingly, an increase in the number of hook portions of the front shield 90 can be prevented, and thus the configuration of the front shield 90 can be prevented from becoming complicated.

The flange portion 10 of the lens unit 30 has two hook portion engaging ribs 13. The two hook portion engaging ribs 13 are provided at positions respectively corresponding to the second side 10b and the fourth side 10d facing the second side 10b of the third surface 10e, and engage with the first hook portion 91 and the second hook portion 92 of the front shield 90, respectively. The hook portion engaging rib 13 is also employed in the first embodiment.

FIG. 20 is an enlarged view of a portion B in FIG. 18. FIG. 20 illustrates a state in which the first hook portion 91 is engaged with the second side 10b of the flange portion 10. Similarly to the fourth hook portion 94, the first hook portion 91 includes the pair of extending pieces 97 and the connecting piece 98. The first hook portion 91 is defined by the pair of extending pieces 97 and the connecting piece 98, and has an engagement hole 99 that engages with the hook portion engaging rib 13. The same applies to the second hook portion 92. Accordingly, engagement holes provided in two hook portions engage with the hook portion engaging ribs 13, and the front shield 90 can be more reliably attached to the flange portion 10.

Each hook portion engaging rib 13 has a slick surface 13a. The slick surface 13a plays the same role as the sliding surface 12a of the crush rib 12 in the first embodiment when the front shield 90 is attached to the flange portion 10.

That is, when the front shield 90 is attached to the flange portion 10, the connecting piece 98 of the first hook portion 91 comes into contact with the slick surface 13a of the hook portion engaging rib 13 as the front shield 90 approaches the third surface 10e of the flange portion 10. When the front shield 90 is brought closer to the third surface 10e of the flange portion 10, the slick surface 13a pushes and expands the first hook portion 91. When the front shield 90 is further brought closer to the third surface 10e of the flange portion 10, the connecting piece 98 climbs over the slick surface 13a, reaching the state illustrated in FIG. 20 in which the first hook portion 91 engages with the second side 10b of the flange portion 10 due to an elastic force of the extending piece 97. Such an engagement process also applies to the relationship between the second hook portion 92 and the other hook portion engaging rib 13.

The slick surface 13a has a first angle θ₂ inclined with respect to the direction parallel to the optical axis L. The first angle θ₁ is set to be smaller than the second angle θ₂ of the sliding surface 12a described in the first embodiment. That is, the slick surface 13a is inclined at an angle smaller than a predetermined angle.

When the front shield 90 is attached to the flange portion 10, even if the connecting piece 98 of the first hook portion 91 comes into contact with and slides on the slick surface 13a, since an inclination angle of the slick surface 13a is small, a large force is less likely to act on the slick surface 13a, and the slick surface 13a is less likely to be scraped than expected to generate unnecessary shavings.

That is, when the front shield 90 is attached to the flange portion 10, the slick surfaces 13a of the hook portion engaging ribs 13, on which two hook portions come into contact and slide, are slightly inclined with respect to the two hook portions, the front shield 90 can be easily pushed into the flange portion 10.

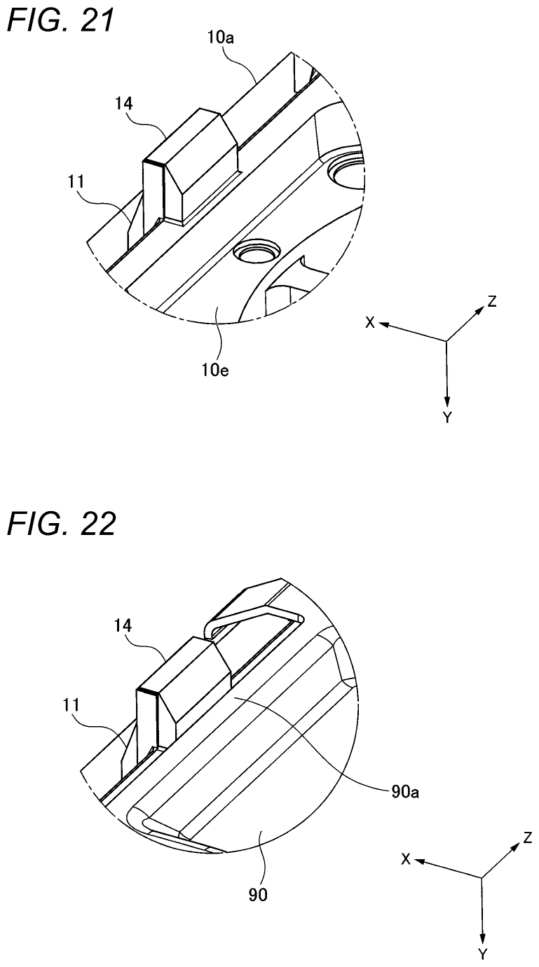

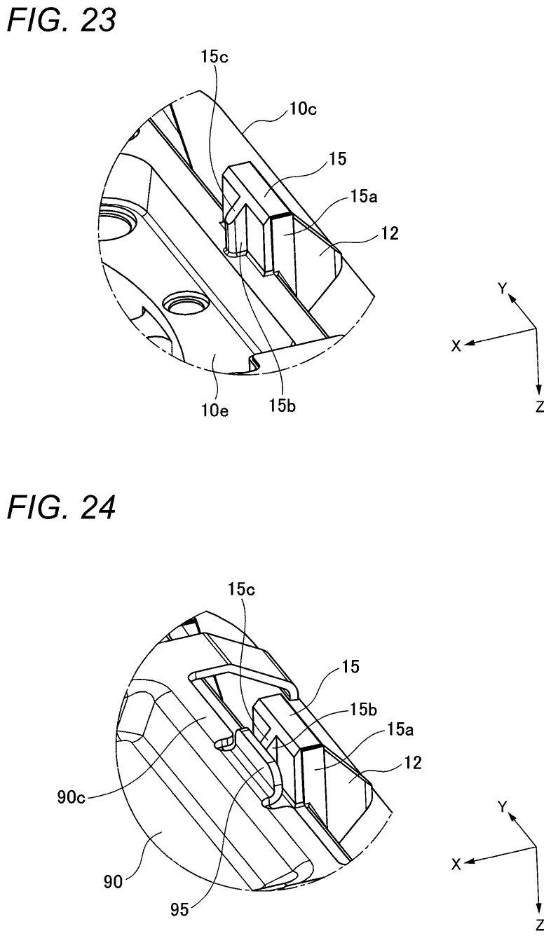

The front shield 90 is attached to the flange portion 10 not only by the above-described hook portion but also by other configurations. Hereinafter, other configurations will be described. FIG. 21 is an enlarged view of a portion C in FIG. 11 as viewed obliquely from above. FIG. 22 is an enlarged view of a portion D in FIG. 18 as viewed obliquely from above. FIG. 23 is an enlarged view of a portion E in FIG. 11 as viewed obliquely from above. FIG. 24 is an enlarged view of a portion F in FIG. 18 as viewed obliquely from above.

The flange portion 10 of the lens unit 30 includes a first reference protrusion 14 illustrated in FIGS. 11, 21, and 22 and a first crushable protrusion 15 illustrated in FIGS. 11, 23, and 24. The first reference protrusion 14 is a member that is provided at a position corresponding to the first side 10a of the third surface 10e and determines a reference position of the front shield 90 relative to the flange portion 10 when the front shield 90 is attached to the flange portion 10. The first crushable protrusion 15 is a member that is provided at a position corresponding to the third side 10c facing the first side 10a of the third surface 10e and is at least partially crushed when the front shield 90 is attached to the flange portion 10.

Further, the front shield 90 has, at a position corresponding to the seventh side 90c facing the fifth side 90a, a first bent-up piece 95 formed by bending up a part of the front shield 90. The first bent-up piece 95 can be formed, for example, by bending up a part of the front shield 90 adjacent to the seventh side 90c while cutting the part.

The fifth side 90a of the front shield 90 corresponds to the first side 10a of the flange portion 10. When the front shield 90 is attached to the flange portion 10, the fifth side 90a abuts against the first reference protrusion 14 of the flange portion 10. That is, the fifth side 90a of the front shield 90 is brought into contact with the first reference protrusion 14, and the front shield 90 is pushed into the flange portion 10 while positioning the front shield 90.

At this time, the first bent-up piece 95 provided on the seventh side 90c of the front shield 90 abuts against the first crushable protrusion 15 of the flange portion 10. When the front shield 90 is further pushed into the flange portion 10, at least a part of the first crushable protrusion 15 is crushed, and the front shield 90 is sandwiched in an X direction by the first reference protrusion 14 and the first crushable protrusion 15, and is attached to and held by the flange portion 10.

The front shield 90 can be attached to the flange portion 10 with a simple configuration using the first bent-up piece 95 formed by bending up a part of the front shield 90.

As illustrated in FIGS. 23 and 24, the first crushable protrusion 15 includes a protrusion main body 15a extending from the third surface 10e of the flange portion 10 toward the circuit board 40, and a crush rib piece 15b protruding from the protrusion main body 15a toward the first bent-up piece 95 of the front shield 90. Accordingly, when the front shield 90 is attached to the flange portion 10, only the crush rib piece 15b comes into contact with the first bent-up piece 95, and thus it is possible to prevent generation of shavings during crushing.

In particular, the crush rib piece 15b of the first crushable protrusion 15 has a tapered surface 15c inclined from the protrusion main body 15a toward the first bent-up piece 95 of the front shield 90. Accordingly, when the front shield 90 is attached to the flange portion 10, the first bent-up piece 95 of the front shield 90 is deformed while being in contact with the tapered surface 15c, and thus the front shield 90 can be easily pushed into the flange portion 10.

The first bent-up piece 95 of the front shield 90 has a substantially L-shaped cross section as viewed from a Y direction. Accordingly, since the first bent-up piece 95 comes into contact with the first crushable protrusion 15 of the flange portion 10 over a large contact surface, it is possible to prevent the generation of shavings.

The flange portion 10 further includes a second reference protrusion 16 and a second crushable protrusion 17. The second reference protrusion 16 is a member that is provided at a position corresponding to the second side 10b adjacent to the first side 10a and the third side 10c of the third surface 10e of the flange portion 10, and determines a reference position of the front shield 90 relative to the flange portion 10 when the front shield 90 is attached to the flange portion 10. The second crushable protrusion 17 is a member that is provided at a position corresponding to the fourth side 10d facing the second side 10b of the third surface 10e and is at least partially crushed when the front shield 90 is attached to the flange portion 10.

The front shield 90 further has, at a position corresponding to the eighth side 90d, a second bent-up piece 96 formed by bending up a part of the front shield 90, similarly to the first bent-up piece 95. The second bent-up piece 96 abuts against the second crushable protrusion 17 of the flange portion 10. The relationship between the second bent-up piece 96 and the second crushable protrusion 17 is the same as the relationship between the first bent-up piece 95 and the first crushable protrusion 15.

Accordingly, when the front shield 90 is attached to the flange portion 10, the first bent-up piece 95 and the second bent-up piece 96 of the front shield 90 abut against the first crushable protrusion 15 and the second crushable protrusion 17 of the flange portion 10 while the reference position of the front shield 90 is determined using the first reference protrusion 14 and the second reference protrusion 16 of the flange portion 10, and thus the attachment can be performed more smoothly.

In the embodiment, as illustrated in FIGS. 21 and 22, the reference rib 11 and the first reference protrusion 14 are integrally formed, and as illustrated in FIGS. 23 and 24, the crush rib 12 and the first crushable protrusion 15 are integrally formed. Accordingly, the reference rib 11 and the first reference protrusion 14 can be easily formed in a space-saving manner, and the crush rib 12 and the first crushable protrusion 15 can be easily formed in a space-saving manner.

Note that the configurations of the four hook portions (first embodiment) or the two hook portions (first embodiment) described above and the first bent-up piece 95 and the second bent-up piece 96 are both configurations for attaching the front shield 90 to the flange portion 10 of the lens unit 30, but only one of the configurations may be adopted.

As described above, at least the following matters are described in the present disclosure. Components corresponding to those in the embodiment are illustrated in parentheses, but the present disclosure is not limited thereto.
(A1) A vehicular camera (vehicular camera 100) including:
a lens unit (lens unit 30) including a lens barrel (lens barrel 31) having a first tubular portion along an optical axis (optical axis L) and including a first end portion of the first tubular portion and a second end portion (second end portion 31b) opposite to the first end portion (first end portion 31a), at least one lens (lens 35) disposed in the lens barrel, and a flange portion (flange portion 10) formed at the second end portion of the lens barrel to spread outward in a direction orthogonal to the optical axis;
an imaging element (imaging element 50) disposed on the optical axis and closer to the second end portion than the first end portion of the first tubular portion of the lens barrel;
a circuit board (circuit board 40) including a first surface (first surface 40a) and a second surface (second surface 40b) opposite to the first surface, the imaging element being disposed on the first surface;
a housing (housing 60) having a second tubular portion along the optical axis, including a third end portion (third end portion 63) of the second tubular portion and a fourth end portion (fourth end portion 64) opposite to the third end portion and disposed farther, than the third end portion of the second tubular portion, away from the first end portion of the first tubular portion of the lens barrel, the third end portion of the second tubular portion supporting the flange portion of the lens unit, and configured to accommodate the imaging element and the circuit board; and
a shield (front shield 90) made of metal and attached to a third surface (third surface 10e) of the flange portion of the lens unit, the third surface facing the imaging element, in which
the flange portion of the lens unit has a rectangular shape in a plan view orthogonal to the optical axis, and has a first side (first side 10a), a second side (second side 10b), a third side (third side 10c), and a fourth side (fourth side 10d),
the flange portion includes
a reference rib (reference rib 11) provided at a position corresponding to the first side of the third surface and configured to determine a reference position of the lens unit relative to the housing when the lens unit is attached to the third end portion of the housing, and
a crush rib (crush rib 12) provided at a position corresponding to the third side facing the first side of the third surface, the crush rib being at least partially crushed when the lens unit is attached to the third end portion of the housing,
the shield has a rectangular shape in the plan view orthogonal to the optical axis and has a fifth side (fifth side 90a), a sixth side (sixth side 90b), a seventh side (seventh side 90c), and an eighth side (eighth side 90d), the fifth side corresponds to the first side of the flange portion, the sixth side corresponds to the second side of the flange portion, the seventh side corresponds to the third side of the flange portion, and the eighth side corresponds to the fourth side of the flange portion, and
the shield includes
a first hook portion (first hook portion 91) that is provided at a position corresponding to the sixth side, is elastically deformable, and engages with the flange portion of the lens unit, and
a second hook portion (second hook portion 92) that is provided at a position corresponding to the eighth side facing the sixth side, is elastically deformable, and engages with the flange portion of the lens unit.

Accordingly, the shield that shields noise can be easily attached to the flange portion of the lens unit using a simple configuration including two elastically deformable hook portions, and the shield can be prevented from falling off the flange portion.
(A2) The vehicular camera according to (A1), in which
the fifth side and the seventh side of the shield have no hook portions other than the first hook portion and the second hook portion.

Accordingly, an increase in the number of hook portions can be prevented, and thus the configuration of the shield can be prevented from becoming complicated.
(A3) The vehicular camera according to (A1), in which
the flange portion of the lens unit has hook portion engaging ribs (hook portion engaging ribs 13) provided at positions respectively corresponding to the second side and the fourth side facing the second side of the third surface and configured to respectively engage with the first hook portion and the second hook portion of the shield, and
the first hook portion and the second hook portion of the shield include engagement holes engaging with the hook portion engaging ribs.

Accordingly, the engagement holes provided in two hook portions of the shield engage with the hook portion engaging ribs of the flange portion, and the shield can be more reliably attached to the flange portion.
(A4) The vehicular camera according to (A3), in which
the hook portion engaging ribs have slick surfaces (slick surfaces 13a) inclined to push and expand the first hook portion and the second hook portion while the first hook portion and the second hook portion slide when the shield is attached to the flange portion of the lens unit,
the crush rib has a sliding surface (sliding surface 12a) sliding with respect to an inner surface of the housing when the flange portion of the lens unit is attached to the third end portion of the housing, and
a first angle (first angle θ₁) inclined with respect to a direction parallel to the optical axis of each of the slick surfaces is smaller than a second angle (second angle θ₂) inclined with respect to the direction parallel to the optical axis of the sliding surface.

Accordingly, when the shield is attached to the flange portion, the slick surfaces of the hook portion engaging ribs, on which two hook portions come into contact and slide, are slightly inclined with respect to the two hook portions, and thus the shield can be easily pushed into the flange portion.
(A5) The vehicular camera according to (A1), in which
the flange portion includes
a first reference protrusion (first reference protrusion 14) provided at a position corresponding to the first side of the third surface and configured to determine a reference position of the shield relative to the flange portion when the shield is attached to the flange portion, and
a first crushable protrusion (first crushable protrusion 15) provided at a position corresponding to the third side facing the first side of the third surface, the first crushable protrusion being at least partially crushed when the shield is attached to the flange portion,
the fifth side of the shield corresponds to the first side of the flange portion and abuts against the first reference protrusion of the flange portion,
the shield has, at a position corresponding to the seventh side facing the fifth side, a first bent-up piece (first bent-up piece 95) formed by bending up a part of the shield, and
the first bent-up piece abuts against the first crushable protrusion of the flange portion.

Accordingly, the shield can be attached to the flange portion with a simple configuration using the first bent-up piece formed by bending up a part of the shield.
(A6) The vehicular camera according to (A5), in which
the first crushable protrusion of the flange portion includes a protrusion main body (protrusion main body 15a) extending from the third surface of the flange portion toward the circuit board, and a crush rib piece (crush rib piece 15b) protruding from the protrusion main body toward the first bent-up piece of the shield.

Accordingly, when the shield is attached to the flange portion, only the crush rib piece comes into contact with the first bent-up piece, and thus it is possible to prevent generation of shavings during crushing.
(A7) The vehicular camera according to (A6), in which
the crush rib piece of the first crushable protrusion has a tapered surface (tapered surface 15c) inclined from the protrusion main body toward the first bent-up piece of the shield.

Accordingly, when the shield is attached to the flange portion, the first bent-up piece of the shield is deformed while being in contact with the tapered surface, and thus the shield can be easily pushed into the flange portion.
(A8) The vehicular camera according to (A5), in which
the first bent-up piece of the shield has a substantially L-shaped cross section.

Accordingly, since the first bent-up piece comes into contact with the first crushable protrusion of the flange portion over a large contact surface, it is possible to prevent the generation of shavings.
(A9) The vehicular camera according to (A5), in which
the flange portion further includes
a second reference protrusion (second reference protrusion 16) provided at a position corresponding to the second side adjacent to the first side and the third side of the third surface, and configured to determine a reference position of the shield relative to the flange portion when the shield is attached to the flange portion, and
a second crushable protrusion (second crushable protrusion 17) provided at a position corresponding to the fourth side facing the second side of the third surface, the second crushable protrusion being at least partially crushed when the shield is attached to the flange portion,
the shield further has, at a position corresponding to the eighth side, a second bent-up piece (second bent-up piece 96) formed by bending up a part of the shield, and
the second bent-up piece abuts against the second crushable protrusion of the flange portion.

Accordingly, when the shield is attached to the flange portion, the first bent-up piece and the second bent-up piece of the shield abut against the first crushable protrusion and the second crushable protrusion of the flange portion while the reference position of the shield is determined using the first reference protrusion and the second reference protrusion of the flange portion, and thus the attachment can be performed more smoothly.
(A10) The vehicular camera according to (A1), in which
the reference rib and the first reference protrusion are integrally formed, and
the crush rib and the first crushable protrusion are integrally formed.

Accordingly, the reference rib and the first reference protrusion can be easily formed in a space-saving manner, and the crush rib and the first crushable protrusion can be easily formed in a space-saving manner.
(B1) A vehicular camera (vehicular camera 100) including:
a lens unit (lens unit 30) including a lens barrel (lens barrel 31) having a first tubular portion along an optical axis (optical axis L) and including a first end portion of the first tubular portion and a second end portion (second end portion 31b) opposite to the first end portion (first end portion 31a), at least one lens (lens 35) disposed in the lens barrel, and a flange portion (flange portion 10) formed at the second end portion of the lens barrel to spread outward in a direction orthogonal to the optical axis;
an imaging element (imaging element 50) disposed on the optical axis and closer to the second end portion than the first end portion of the first tubular portion of the lens barrel;
a circuit board (circuit board 40) including a first surface (first surface 40a) and a second surface (second surface 40b) opposite to the first surface, the imaging element being disposed on the first surface;
a housing (housing 60) having a second tubular portion along the optical axis, including a third end portion (third end portion 63) of the second tubular portion and a fourth end portion (fourth end portion 64) opposite to the third end portion and disposed farther, than the third end portion of the second tubular portion, away from the first end portion of the first tubular portion of the lens barrel, the third end portion of the second tubular portion supporting the flange portion of the lens unit, and configured to accommodate the imaging element and the circuit board; and
a shield (front shield 90) made of metal and attached to a third surface (third surface 10e) of the flange portion of the lens unit, the third surface facing the imaging element, in which
the flange portion of the lens unit has a rectangular shape in a plan view orthogonal to the optical axis, and has a first side (first side 10a), a second side (second side 10b), a third side (third side 10c), and a fourth side (fourth side 10d),
the flange portion includes
a first reference protrusion (first reference protrusion 14) provided at a position corresponding to the first side of the third surface and configured to determine a reference position of the shield relative to the flange portion when the shield is attached to the flange portion, and
a first crushable protrusion (first crushable protrusion 15) provided at a position corresponding to the third side facing the first side of the third surface, the first crushable protrusion being at least partially crushed when the shield is attached to the flange portion,
the shield has a rectangular shape in the plan view orthogonal to the optical axis and has a fifth side (fifth side 90a), a sixth side (sixth side 90b), a seventh side (seventh side 90c), and an eighth side (eighth side 90d), the fifth side corresponds to the first side of the flange portion and abuts against the first reference protrusion of the flange portion, the sixth side corresponds to the second side of the flange portion, the seventh side corresponds to the third side of the flange portion, and the eighth side corresponds to the fourth side of the flange portion,
the shield has, at a position corresponding to the seventh side facing the fifth side, a first bent-up piece (first bent-up piece 95) formed by bending up a part of the shield, and
the first bent-up piece abuts against the first crushable protrusion of the flange portion.

Accordingly, the shield can be attached to the flange portion with a simple configuration using the first bent-up piece formed by bending up a part of the shield.
(B2) The vehicular camera according to (B1), in which
the first crushable protrusion of the flange portion includes a protrusion main body (protrusion main body 15a) extending from the third surface of the flange portion toward the circuit board, and a crush rib piece (crush rib piece 15b) protruding from the protrusion main body toward the first bent-up piece of the shield.

Accordingly, when the shield is attached to the flange portion, only the crush rib piece comes into contact with the first bent-up piece, and thus it is possible to prevent generation of shavings during crushing.
(B3) The vehicular camera according to (B2), in which
the crush rib piece of the first crushable protrusion has a tapered surface (tapered surface 15c) inclined from the protrusion main body toward the first bent-up piece of the shield.

Accordingly, when the shield is attached to the flange portion, the first bent-up piece of the shield is deformed while being in contact with the tapered surface, and thus the shield can be easily pushed into the flange portion.
(B4) The vehicular camera according to (B1), in which
the first bent-up piece of the shield has a substantially L-shaped cross section.

Accordingly, since the first bent-up piece comes into contact with the first crushable protrusion of the flange portion over a large contact surface, it is possible to prevent the generation of shavings.
(B5) the vehicular camera according to (B1), in which
the flange portion further includes
a second reference protrusion (second reference protrusion 16) provided at a position corresponding to the second side adjacent to the first side and the third side of the third surface, and configured to determine a reference position of the shield relative to the flange portion when the shield is attached to the flange portion, and
a second crushable protrusion (second crushable protrusion 17) provided at a position corresponding to the fourth side facing the second side of the third surface, the second crushable protrusion being at least partially crushed when the shield is attached to the flange portion,
the shield further has, at a position corresponding to the eighth side, a second bent-up piece (second bent-up piece 96) formed by bending up a part of the shield, and
the second bent-up piece abuts against the second crushable protrusion of the flange portion.

Accordingly, when the shield is attached to the flange portion, the first bent-up piece and the second bent-up piece of the shield abut against the first crushable protrusion and the second crushable protrusion of the flange portion while the reference position of the shield is determined using the first reference protrusion and the second reference protrusion of the flange portion, and thus the attachment can be performed more smoothly.
(B6) The vehicular camera according to (B1), in which
the flange portion includes
a reference rib (reference rib 11) provided at a position corresponding to the first side of the third surface and configured to determine a reference position of the lens unit relative to the housing when the lens unit is attached to the third end portion of the housing, and
a crush rib (crush rib 12) provided at a position corresponding to the third side facing the first side of the third surface, the crush rib being at least partially crushed when the lens unit is attached to the third end portion of the housing, and
the shield includes
a first hook portion (first hook portion 91) that is provided at a position corresponding to the sixth side, is elastically deformable, and engages with the flange portion of the lens unit, and
a second hook portion (second hook portion 92) that is provided at a position corresponding to the eighth side facing the sixth side, is elastically deformable, and engages with the flange portion of the lens unit.

Accordingly, the shield that shields noise can be easily attached to the flange portion of the lens unit using a simple configuration including two elastically deformable hook portions, and the shield can be prevented from falling off the flange portion.
(B7) The vehicular camera according to (B6), in which
the fifth side and the seventh side of the shield have no hook portions other than the first hook portion and the second hook portion.

Accordingly, an increase in the number of hook portions can be prevented, and thus the configuration of the shield can be prevented from becoming complicated.
(B8) The vehicular camera according to (B6), in which
the flange portion of the lens unit has hook portion engaging ribs (hook portion engaging ribs 13) provided at positions respectively corresponding to the second side and the fourth side facing the second side of the third surface and configured to respectively engage with the first hook portion and the second hook portion of the shield, and
the first hook portion and the second hook portion of the shield include engagement holes engaging with the hook portion engaging ribs.

Accordingly, the engagement holes provided in two hook portions of the shield engage with the hook portion engaging ribs of the flange portion, and the shield can be more reliably attached to the flange portion.
(B9) The vehicular camera according to (B8), in which
the hook portion engaging ribs have slick surfaces (slick surfaces 13a) inclined to push and expand the first hook portion and the second hook portion while the first hook portion and the second hook portion slide when the shield is attached to the flange portion of the lens unit,
the crush rib has a sliding surface (sliding surface 12a) sliding with respect to an inner surface of the housing when the flange portion of the lens unit is attached to the third end portion of the housing, and
a first angle (first angle θ₁) inclined with respect to a direction parallel to the optical axis of each of the slick surfaces is smaller than a second angle (second angle θ₂) inclined with respect to the direction parallel to the optical axis of the sliding surface.

Accordingly, when the shield is attached to the flange portion, the slick surfaces of the hook portion engaging ribs, on which two hook portions come into contact and slide, are slightly inclined with respect to the two hook portions, and thus the shield can be easily pushed into the flange portion.
(B10) The vehicular camera according to (B6), in which
the reference rib and the first reference protrusion are integrally formed, and
the crush rib and the first crushable protrusion are integrally formed.

Accordingly, the reference rib and the first reference protrusion can be easily formed in a space-saving manner, and the crush rib and the first crushable protrusion can be easily formed in a space-saving manner.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiments described above may be combined freely in a range without departing from the gist of the invention.

### INDUSTRIAL APPLICABILITY

The present disclosure is useful for a vehicular camera in which a shield that shields noise can be easily attached to a flange portion of a lens unit.

### CROSS-REFERENCE TO RELATED APPLICATIONS

This application is based on and claims priority under 35 USC 119 from Japanese Patent Application No. 2024-229296 filed on Dec. 25, 2024, the contents of which are incorporated herein by reference.

What is claimed is:

1. A vehicular camera comprising:
a lens unit including a lens barrel having a first tubular portion along an optical axis and including a first end portion of the first tubular portion and a second end portion opposite to the first end portion, at least one lens disposed in the lens barrel, and a flange portion formed at the second end portion of the lens barrel to spread outward in a direction orthogonal to the optical axis;
an imaging element disposed on the optical axis and closer to the second end portion than the first end portion of the first tubular portion of the lens barrel;
a circuit board including a first surface and a second surface opposite to the first surface, the imaging element being disposed on the first surface;
a housing accommodating the imaging element and the circuit board, having a second tubular portion along the optical axis, including a third end portion of the second tubular portion and a fourth end portion opposite to the third end portion and disposed farther, than the third end portion of the second tubular portion, away from the first end portion of the first tubular portion of the lens barrel, the third end portion of the second tubular portion supporting the flange portion of the lens unit; and
a shield made of metal and attached to a third surface of the flange portion of the lens unit, the third surface facing the imaging element, wherein
the flange portion of the lens unit has a rectangular shape in a plan view orthogonal to the optical axis, and has a first side, a second side, a third side, and a fourth side,
the flange portion includes
a first reference protrusion provided at a position corresponding to the first side of the third surface and configured to determine a reference position of the shield relative to the flange portion when the shield is attached to the flange portion, and
a first crushable protrusion provided at a position corresponding to the third side facing the first side of the third surface, the first crushable protrusion being at least partially crushed when the shield is attached to the flange portion,
the shield has a rectangular shape in the plan view orthogonal to the optical axis and has a fifth side, a sixth side, a seventh side, and an eighth side, the fifth side corresponds to the first side of the flange portion and abuts against the first reference protrusion of the flange portion, the sixth side corresponds to the second side of the flange portion, the seventh side corresponds to the third side of the flange portion, and the eighth side corresponds to the fourth side of the flange portion,
the shield has, at a position corresponding to the seventh side facing the fifth side, a first bent-up piece formed by bending up a part of the shield, and
the first bent-up piece abuts against the first crushable protrusion of the flange portion.

2. The vehicular camera according to claim 1, wherein
the first crushable protrusion of the flange portion includes a protrusion main body extending from the third surface of the flange portion toward the circuit board, and a crush rib piece protruding from the protrusion main body toward the first bent-up piece of the shield.

3. The vehicular camera according to claim 2, wherein
the crush rib piece of the first crushable protrusion has a tapered surface inclined from the protrusion main body toward the first bent-up piece of the shield.

4. The vehicular camera according to claim 1, wherein
the first bent-up piece of the shield has a substantially L-shaped cross section.

5. The vehicular camera according to claim 1, wherein
the flange portion further includes
a second reference protrusion provided at a position corresponding to the second side adjacent to the first side and the third side of the third surface, and configured to determine a reference position of the shield relative to the flange portion when the shield is attached to the flange portion, and
a second crushable protrusion provided at a position corresponding to the fourth side facing the second side of the third surface, the second crushable protrusion being at least partially crushed when the shield is attached to the flange portion,
the shield further has, at a position corresponding to the eighth side, a second bent-up piece formed by bending up a part of the shield, and
the second bent-up piece abuts against the second crushable protrusion of the flange portion.

6. The vehicular camera according to claim 1, wherein
the flange portion includes
a reference rib provided at a position corresponding to the first side of the third surface and configured to determine a reference position of the lens unit relative to the housing when the lens unit is attached to the third end portion of the housing, and
a crush rib provided at a position corresponding to the third side facing the first side of the third surface, the crush rib being at least partially crushed when the lens unit is attached to the third end portion of the housing, and
the shield includes
a first hook portion that is provided at a position corresponding to the sixth side, is elastically deformable, and engages with the flange portion of the lens unit, and
a second hook portion that is provided at a position corresponding to the eighth side facing the sixth side, is elastically deformable, and engages with the flange portion of the lens unit.

7. The vehicular camera according to claim 6, wherein
the fifth side and the seventh side of the shield have no hook portions other than the first hook portion and the second hook portion.

8. The vehicular camera according to claim 6, wherein
the flange portion of the lens unit has hook portion engaging ribs provided at positions respectively corresponding to the second side and the fourth side facing the second side of the third surface and configured to respectively engage with the first hook portion and the second hook portion of the shield, and
the first hook portion and the second hook portion of the shield include engagement holes engaging with the hook portion engaging ribs.

9. The vehicular camera according to claim 8, wherein
the hook portion engaging ribs have slick surfaces inclined to push and expand the first hook portion and the second hook portion while the first hook portion and the second hook portion slide when the shield is attached to the flange portion of the lens unit,
the crush rib has a sliding surface sliding with respect to an inner surface of the housing when the flange portion of the lens unit is attached to the third end portion of the housing, and
a first angle inclined with respect to a direction parallel to the optical axis of each of the slick surfaces is smaller than a second angle inclined with respect to the direction parallel to the optical axis of the sliding surface.

10. The vehicular camera according to claim 6, wherein
the reference rib and the first reference protrusion are integrally formed, and
the crush rib and the first crushable protrusion are integrally formed.
